(19) United States
(12) Patent Application Publication
(10) Pub. No.: US 2026/0347579 A1
(43) Pub. Date: Nov. 5, 2026

(54) POLYETHYLENE BLENDS CONTAINING VIRGIN AND RECYCLED HDPE MATERIALS

(71) Applicant: Dow Global Technologies LLC, Midland, MI (US)

(72) Inventors: Glendimar Molero, Clute, TX (US); Elva L. Lugo, Manvel, TX (US); Xiaosong Wu, Sugar Land, TX (US); Cliff R. Mure, Hillsborough, NJ (US)

(21) Appl. No.: 19/106,406

(22) PCT Filed: Oct. 11, 2023
(86) PCT No.: PCT/US2023/034869

§ 371 Date: Feb. 25, 2025

Related U.S. Application Data
(60) Provisional application No. 63/379,036, filed on Oct. 11, 2022.

(51) Int. Cl. C08L 23/06; B29C 49/00; B29K 23/00; B29K 105/00; B29K 105/26

(52) U.S. Cl. CPC C08L 23/06; B29C 49/0005; B29K 2023/065; B29K 2105/0088; B29K 2105/26; B29K 2995/0077; B29K 2995/0089; C08L 2205/025; C08L 2205/03; C08L 2207/062; C08L 2207/20

(57) ABSTRACT

A high-density polyethylene blend that contains from 25 to 90 weight percent recycled high-density polyethylene; and from 10 to 75 weight percent virgin bimodal high-density polyethylene having a density from 0.94 g/mL to 0.956 g/mL and a flow index (I₂₁) from 25 g/10 min. to 40 g/10 min, exhibits good physical properties for blow molded articles, including good melt strength, rigidity, and crack resistance.

### FIELD

This application relates to polyethylene polymers.

### INTRODUCTION

Plastics recycling is an important part of plastic waste management. Recycled plastics may not meet the physical property specifications that are needed for common end uses. As a result, recycled plastics are frequently blended with freshly made (“virgin”) plastic in order to provide a blend that can meet specifications needed for commercial use. Such blends desirably contain as much recycled plastic as practical, in order to maximize the amount of recycled plastic used and minimize the amount of virgin plastic needed.

High-density polyethylene (HDPE) is commonly used to make blow-molded items, such as jars, beverage bottles and other containers. To be most useful in blow-molding applications, HDPE polymers need to have good melt strength, high rigidity (so that containers can be stacked without deforming) and resistance to cracking (so that containers will not crack and leak). Resistance to cracking is commonly measured by ASTM D1693, which measures environmental stress crack resistance (ESCR), and/or ASTM F2136, which measures notched constant ligament stress (NCLS) resistance.

Recycled HDPE polymers may have crack resistance that is too low for use in blow-molded bottles. This may be especially true for post-consumer recycled (“PCR”) HDPE polymers. Some virgin polymers that can be blended to improve the crack resistance may also have the effect of reducing rigidity.

It is desirable to identify blends of virgin HDPE polymers with high levels of recycled HDPE polymers (and especially PCR HDPE polymers) that have a good balance of rigidity and crack resistance.

### SUMMARY

We have discovered that selection of a virgin bimodal HDPE with proper density and flow index can provide a blend with recycled HDPE that has both good rigidity and good ESCR, as well as other properties desirable for blow molded parts such as bottles.

An aspect of the present invention is a high-density polyethylene (HDPE) blend comprising: (a) from 25 to 90 weight percent recycled HDPE; and (b) from 10 to 75 weight percent virgin bimodal HDPE having a density from 0.940 g/mL to 0.956 g/mL and a flow index (I₂₁) from 25 g/10 min. to 40 g/10 min. The HDPE blend is a post-reactor blend of the recycled HDPE and the virgin bimodal HDPE.

Another aspect of this invention is a shaped article comprising an HDPE blend of this invention.

Another aspect of this invention is a blow molding process comprising the steps of: (1) placing a quantity of molten HDPE blend in a mold cavity, (2) blowing a gas into the molten HDPE blend, causing it to expand and assume the approximate shape of the mold cavity, and (3) cooling the HDPE blend, wherein the HDPE blend is an HDPE blend of this invention.

Another aspect of this invention is a blow molded article prepared by the blow molding process.

### BRIEF DESCRIPTION OF THE DRAWINGS

FIG. 1 illustrates the melt strength over a range of draw velocities from 1 to 120 mm/s for three virgin HDPE polymers: two virgin bimodal HDPE polymers within the scope of the present invention and one virgin unimodal HDPE polymer that is comparative.

FIGS. 2 to 5 illustrate the melt strength under similar conditions for blends of the three virgin HDPE polymers with recycled HDPE, containing respectively 25 weight percent, 50 weight percent, 75 weight percent and 90 weight percent recycled HDPE.

FIG. 6 illustrates the molecular weight profiles of the two virgin bimodal HDPE polymers within the scope of the present invention and the one unimodal HDPE polymer that is comparative, as measured by Gel Permeation Chromatography.

### DETAILED DESCRIPTION

### HDPE Polymer—General Characteristics

Embodiments of this invention use high-density polyethylene polymers (HDPE) of the virgin type and HDPE polymers of the recycled type. In general the HDPE is a polymer that predominantly contains repeating units derived from ethylene, optionally with repeating units derived from one or more unsaturated comonomers, and that has a density from 0.93 g/cc to 0.98 g/cc.

In some embodiments, the HDPE is a homopolymer containing no measurable remnants of comonomer. In some embodiments, the HDPE is a copolymer in which a minor amount of repeating units are derived from unsaturated comonomers.

Examples of suitable comonomers used to make HDPE may include alpha-olefins. Suitable alpha-olefins may include those containing from 3 to 20 carbon atoms (C₃-C₂₀). For example, the alpha-olefin may be a C₄-C₂₀ alpha-olefin, a C₄-C₁₂ alpha-olefin, a C₃-C₁₀ alpha-olefin, a C₃-C₈ alpha-olefin, a C₄-C₈ alpha-olefin, or a C₆-C₈ alpha-olefin. In some embodiments, the alpha-olefin is selected from the group consisting of propylene, 1-butene, 1-pentene, 1-hexene, 4-methyl-1-pentene, 1-heptene, 1-octene, 1-nonene and 1-decene. In other embodiments, the alpha-olefin is selected from the group consisting of propylene, 1-butene, 1-hexene, and 1-octene. In further embodiments, the alpha-olefin is selected from the group consisting of 1-hexene and 1-octene.

In some embodiments, an HDPE copolymer contains at least 95 weight percent repeating units derived from ethylene, or at least 96 weight percent or at least 97 weight percent or at least 98 weight percent or at least 99 weight percent or at least 99.5 weight percent, with the remaining repeating units derived from unsaturated comonomers. In some embodiments, an HDPE copolymer contains at least 4 weight percent repeating units derived from comonomers, or at least 3 weight percent or at least 2 weight percent or at least 1 weight percent or at least 99.5 weight percent, with the remaining repeating units derived from ethylene monomer. It is well known how to select comonomers and comonomer content to obtain the known molecular weight and other properties for an HDPE copolymer. In some embodiments, wherein the comonomer is a higher molecular weight comonomer such as 1-octene, the comonomer content may be in the higher part of the range listed above. In some embodiments, wherein the comonomer is a lower molecular weight comonomer such as 1-butene, the comonomer content may be in the lower part of the range listed above.

### Recycled HDPE

HDPE blends of the present invention contain recycled HDPE. In some embodiments, the recycled HDPE is pre-consumer recycled polyethylene, such as scraps and waste from HDPE manufacturing facilities or from HDPE fabricators. In some embodiments, the recycled HDPE polymer is post-consumer recycled (PCR) HDPE. In some embodiments, the recycled HDPE polymer is a post-industrial recycled HDPE.

The terms “pre-consumer recycled polyethylene” and “post-industrial recycled HDPE” refer to polymers, including blends of polyethylene polymers, recovered from pre-consumer material, as defined by ISO-14021. The generic term pre-consumer recycled polyethylene thus includes blends of polyethylene and other polymers recovered from materials diverted from the waste stream during a manufacturing process. The generic term pre-consumer recycled polyethylene excludes the reutilization of polyethylene materials, such as rework, regrind, or scrap, generated in a process and capable of being reclaimed within the same process that generated it.

The term “post-consumer recycled” (or “PCR”) polyethylene, as used herein, refers to a polyethylene material, such as the PCR HDPE, that includes materials previously used in a consumer or industry application i.e., pre-consumer recycled polyethylene and post-industrial recycled HDPE. PCR polyethylene is typically collected from recycling programs and recycling plants. The PCR polyethylene may include one or more contaminants. The contaminants may be the result of the polyethylene material's use prior to being repurposed for reuse. For example, contaminants may include paper, ink, food residue, or other recycled materials in addition to the polymer, which may result from the recycling process. PCR polyethylene is distinct from virgin polyethylene. A virgin polyethylene does not include materials previously used in a consumer or industry application, whereas the PCR polyethylene does include them. Virgin polyethylene material has not undergone, or otherwise has not been subject to, a heat process or a molding process, after the initial polymer manufacturing process. The physical, chemical, and flow properties of PCR polyethylene polymers differ when compared to virgin polyethylene, which in turn can present challenges to incorporating PCR polyethylene into blends for commercial use.

As used in the present disclosure, “PCR polyethylene” means a PCR ethylene/alpha-olefin copolymer, such as a PCR high-density polyethylene; and optionally other components and additives.

It is contemplated that the PCR polyethylene includes various polyethylene compositions. PCR polyethylene may be sourced from HDPE packaging such as bottles (milk jugs, juice containers), LDPE/LLDPE packaging such as films. PCR polyethylene also includes residue from its original use, residue such as paper, adhesive, ink, nylon, ethylene vinyl alcohol (EVOH), polyethylene terephthalate (PET), and other odor-causing agents. Sources of PCR polyethylene can include, for example, bottle caps and closures, milk, water or orange juice containers, detergent bottles, office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, rotomolded parts (kayaks/coolers), building waste and industrial molding and extrusion scrap.

In embodiments, the polyethylene of the PCR polyethylene comprises low density polyethylene, linear low density polyethylene, or a combination thereof. In embodiments, the PCR polyethylene further comprises residue from its original use, such as paper, adhesive, ink, nylon, ethylene vinyl alcohol (EVOH), polyamide (PA), polyethylene terephthalate (PET), and other organic or inorganic material. Examples of PCR polymers include KWR101-150 and KWR-102 commercially available from KW Plastics, and AVANGARD™ NATURA PCR-LDPCR-100 (“AVANGARD™ 100”) and AVANGARD™ NATURA PCR-LDPCR-150 (“AVANGARD™ 150”) (PCR polymer commercially available from Avangard Innovative LP, Houston, Texas).

In some embodiments the PCR polyethylene is a PCR HDPE available as KWR101-150 from KW Plastics. When measured using a “heat-cool-heat” temperature profile as described in the Test Methods below, KWR101-150 has the DSC properties shown in the table below,

| Sample | 1st Cool | 1st Cool | 2nd Heat | 2nd Heat |
|---|---|---|---|---|
| Description | Delta H cryst | Tc1 | Delta H melt | Tm1 |
| KWR101-150 | 231.4 °C | 121.16 °C | 225.9 °C | 133.51 °C |

wherein: “1st Cool Delta H cryst” measures the enthalpy of crystallization during the first cooling curve; “1st Cool Tc1” measures the crystallization temperature during the first cooling cycle; “2nd Heat Delta H melt measures the enthalpy of fusion during the second heating curve; and “2nd Heat Tm1” measures the melting temperature during the second heating curve.

In embodiments, the PCR polyethylene has a heat of fusion in the range of from 130 to 170 Joule/gram (J/g), measured according to the DSC test method described below. All individual values and subranges of from 130 to 170 J/g are disclosed and incorporated herein; for example, the heat of fusion of the PCR polyethylene can be from 130 to 170 J/g, from 130 to 160 J/g, from 130 to 150 J/g, from 130 to 140 J/g, from 140 to 170 J/g, from 140 to 160 J/g, from 140 to 150 J/g, from 150 to 170 J/g, or from 155 to 170 J/g, when measured according to the DSC test method described below.

In embodiments, the PCR polyethylene has a peak melting temperature (Tm) of from 115 °C to 137 °C, when measured according to the DSC test method describe below. All individual values and subranges of from 115 °C to 137 °C are disclosed and incorporated herein; for example, the peak melting temperature (Tm) of the PCR polymer can be from 121 °C to 135 °C, from 131 °C to 135 °C, from 132 °C to 135 °C or from 133.0 °C to 134.0 °C, when measured according to the DSC test method described below.

In some embodiments, the recycled HDPE has a density of at least 0.94 g/cc or at least 0.95 g/cc or at least 0.955 g/cc or at least 0.958 g/cc. In some embodiments, the recycled HDPE has a density of at most 0.97 g/cc or at most 0.965 g/cc.

In some embodiments, compared to the virgin bimodal HDPE, the recycled HDPE has a characteristic optical defect, determined according to the Gel Characterization Test Method described later, of ______ [TESTING IN PROGRESS—ADD DATA to PCT filing].

In some embodiments the melt index (I₂) of the recycled HDPE ranges from 0.01 g/10 min to 30 g/10 min. All individual values and subranges of 0.01 g/10 min to 30 g/10 min are included and disclosed herein. In some embodiments, the melt index (I₂) of the recycled HDPE is at least 0.1 g/10 min or at least 0.3 g/10 min or at least 0.4 g/10 min or at least 0.5 g/10 min or at least 0.55 g/10 min. In some embodiments, the melt index (I₂) of the recycled HDPE is at most 2 g/10 min or at most 1 g/10 min or at most 0.8 g/10 min or at most 0.7 g/10 min or at most 0.65 g/O min.

In some embodiments, the melt index (I₅) of the recycled HDPE is at least 1 g/10 min or at least 2 g/10 min or at least 2.5 g/10 min or at least 2.75 g/10 min. In some embodiments, the melt index (I₅) of the recycled HDPE is at most 5 g/10 min or at most 4 g/10 min or at most 3.5 g/10 min or at most 3.25 g/10 min.

In some embodiments, the flow index (I₂₁) of the recycled HDPE is at least 30 g/10 min or at least 40 g/10 min or at least 45 g/10 min or at least 50 g/10 min. In some embodiments, the flow index (I₂₁) of the recycled HDPE is at most 100 g/10 min or at most 90 g/10 min or at most 80 g/10 min or at most 70 g/10 min or at most 60 g/10 min.

In some embodiments, the melt flow ratio (I₂₁/I₅) of the recycled HDPE is at least 10 or at least 15 or at least 17 or at least 18. In some embodiments, the melt flow ratio (I₂₁/I₅) of the recycled HDPE is at most 30 or at most 25 or at most 23 or at most 21 or at most 20.

In some embodiments, the number average molecular weight (Mn) of the recycled HDPE is at least 10,000 Da or at least 15,000 Da or at least 18,000 Da. In some embodiments, the number average molecular weight (Mn) of the recycled HDPE is at most 50,000 Da or at most 40,000 Da or at most 30,000 Da or at most 25,000 Da.

In some embodiments, the weight average molecular weight (Mw) of the recycled HDPE is at least 80,000 Da or at least 100,000 Da or at least 110,000 Da. In some embodiments, the weight average molecular weight (Mw) of the recycled HDPE is at most 200,000 Da or at most 160,000 Da or at most 130,000 Da or at most 120,000 Da.

In some embodiments, the molecular weight distribution (Mw/Mn) of the recycled HDPE is at least 3 or at least 4 or at least 5. In some embodiments, the molecular weight distribution (Mw/Mn) of the recycled HDPE is at most 10 or at most 8 or at most 7.

In some embodiments, the tensile yield strength of the recycled HDPE is at least 2500 psi or at least 3000 psi or at least 3500 psi. In some embodiments, the tensile yield strength of the recycled HDPE is at most 7000 psi or at most 5000 psi or at most 4000 psi.

In some embodiments, the flexural modulus of the recycled HDPE is at least 100 ksi or at least 130 ksi or at least 145 ksi. In some embodiments, the flexural modulus of the recycled HDPE is at most 200 ksi or at most 180 ksi or at most 170 ksi. (1 ksi=1000 psi.)

In some embodiments, the ESCR (time to 50% failure rate under the test conditions listed below) of the recycled HDPE is at most 35 hours or at most 30 hours or at most 25 hours or at most 22 hours or at most 20 hours. In some embodiments, the ESCR (time to 50% failure rate under the test conditions listed below) of the recycled HDPE is at least 10 hours or at least 15 hours or at least 18 hours.

Suitable recycled HDPE streams are commercially available, such as from KW Plastics. Others can be prepared by know processes such as: (1) separating HDPE materials having desired properties from a recycle waste stream; (2) washing the separated HDPE materials; and (3) grinding the separated HDPE materials. An example of such a process is described in European Patent 2 697 025 B1.

### Virgin Bimodal HDPE

HDPE blends of the present invention also contain virgin bimodal high-density polyethylene (HDPE) polymer, which is a bimodal HDPE that has not been fabricated or used to make shaped articles after it was pelletized.

The density of the virgin bimodal HDPE is from 0.94 g/cc to 0.956 g/cc. In some embodiments, the density of the virgin bimodal HDPE is at least 0.945 g/cc or at least 0.95 g/cc or at least 0.952 g/cc. In some embodiments, the density of the virgin bimodal HDPE is at most 0.955 g/cc or at most 0.954 g/cc.

The flow index (I₂₁) of the virgin bimodal HDPE is from 25 g/10 min. to 40 g/10 min. In some embodiments, the flow index (I₂₁) of the virgin bimodal HDPE is at least 27 g/10 min or at least 28 g/10 min or at least 29 g/10 min or at least 30 g/10 min. In some embodiments, the flow index (I₂₁) of the virgin bimodal HDPE is at most 38 g/10 min or at most 36 g/10 min or at most 35 g/10 min or at most 34 g/10 min or at most 33 g/10 min or at most 32.5 g/10 min.

In some embodiments, the melt index (12) of the virgin bimodal HDPE is at least 0.05 g/10 min or at least 0.07 g/10 min or at least 0.09 g/10 min or at least 0.11 g/10 min or at least 0.13 g/10 min. In some embodiments, the melt index (I₂) of the virgin bimodal HDPE is at most 0.5 g/10 min or at most 0.4 g/10 min or at most 0.3 g/10 min or at most 0.25 g/10 min or at most 0.22 g/10 min or at most 0.2 g/10 min or at most 0.18 g/10 min.

In some embodiments, the melt index (I₅) of the virgin bimodal HDPE is at least 0.5 g/10 min or at least 0.7 g/10 min or at least 0.8 g/10 min or at least 0.9 g/10 min. In some embodiments, the melt index (I₅) of the virgin bimodal HDPE is at most 5 g/10 min or at most 3 g/10 min or at most 2 g/10 min or at most 1.5 g/10 min or at most 1.3 g/10 min or at most 1.2 g/10 min.

In some embodiments, the melt flow ratio (I₂₁/I₅) of the virgin bimodal HDPE is at least 15 or at least 20 or at least 25 or at least 27 or at least 28 or at least 29. In some embodiments, the melt flow ratio (I₂₁/I₅) of the virgin bimodal HDPE is at most 50 or at most 40 or at most 35 or at most 34 or at most 33.

In some embodiments, the melt strength of the virgin bimodal HDPE at 190 °C is at least 8 cN or at least 9 cN or at least 10 cN. In some embodiments, the melt strength of the virgin bimodal HDPE at 190 °C is at most 15 cN or at most 13 cN or at most 11 cN.

In some embodiments, the number average molecular weight (Mn) of the virgin bimodal HDPE is at least 15,000 Da or at least 17,000 Da or at least 18,000 Da or at least 19,000 Da or at least 20,000 Da. In some embodiments, the number average molecular weight (Mn) of the virgin bimodal HDPE is at most 30,000 Da or at most 28,000 Da or at most 26,000 Da or at most 24,000 Da or at most 22,000 Da.

In some embodiments, the weight average molecular weight (Mw) of the virgin bimodal HDPE is at least 200,000 Da or at least 250,000 Da or at least 300,000 Da or at least 325,000 Da.

In some embodiments, the weight average molecular weight (Mw) of the virgin bimodal HDPE is at most 400,000 Da or at most 350,000 Da or at most 340,000 Da or at most 330,000 Da.

In some embodiments, the molecular weight distribution (Mw/Mn) of the virgin bimodal HDPE is at least 10 or at least 12 or at least 13 or at least 14 or at least 15. In some embodiments, the molecular weight distribution (Mw/Mn) of the virgin bimodal HDPE is at most 25 or at most 20 or at most 19 or at most 18 or at most 17.

In some embodiments, the Z average molecular weight (Mz) of the virgin bimodal HDPE is at least 2,500,000 Da or at least 3,000,000 Da or at least 3,500,000 Da or at least 4,000,000 Da or at least 4,500,000 Da or at least 5,000,000 Da. In some embodiments, the Z average molecular weight (Mz) of the virgin bimodal HDPE is at most 7,000,000 Da or at most 6,000,000 Da or at most 5,700,000 Da or at most 5,500,000 Da.

In some embodiments, the ratio (Mz/Mw) of the virgin bimodal HDPE is at least 14 or at least 14.5 or at least 15 or at least 15.5 or at least 16. In some embodiments, the ratio (Mz/Mw) of the virgin bimodal HDPE is at most 24 or at most 20 or at most 18 or at most 17.

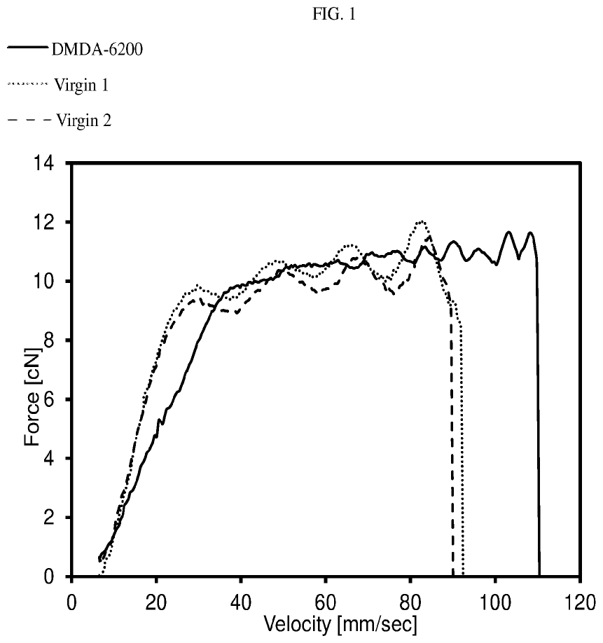

The virgin bimodal HDPE has a bimodal molecular weight distribution, meaning that it comprises a higher molecular weight (HMW) component, and a lower molecular weight (LMW) component. The weight average molecular weight (Mw) of the HMW component is higher than the weight average molecular weight (Mw) of the LMW component. In some embodiments, the molecular weight profile of a virgin bimodal HDPE may form two distinct peaks, as explained and illustrated in U.S. Pat. No. 6,787,608B2 at column 4, lines 4-37 and FIG. 1C. In some embodiments, the molecular weight profile of a virgin bimodal HDPE may form a single peak with a shoulder, as explained and illustrated in U.S. Pat. No. 6,787,608B2 at column 4, lines 4-37 and FIG. 1B. In some embodiments, the molecular weight profile of a virgin bimodal HDPE may form a single peak with a tail, as explained and illustrated in U.S. Pat. No. 6,787,608B2 at column 4, lines 4-37 and FIG. 1A.

In some embodiments of the invention, the LMW Component makes up more than 50 weight percent of the virgin bimodal HDPE or more than 60 weight percent or more than 70 weight percent or more than 75 weight percent. In some embodiments of the invention, the molecular weight profile of a virgin bimodal HDPE shows the HMW component as a shoulder on the LMW component peak.

In some embodiments of the invention, the bimodal nature of the virgin bimodal HDPE is reflected in a high molecular weight distribution (Mw/Mn) or ratio of Mz/Mw, as compared to similar unimodal HDPE.

In some embodiments, the tensile yield strength of the virgin bimodal HDPE is at least 3200 psi or at least 3500 psi or at least 3650 psi. In some embodiments, the tensile yield strength of the virgin bimodal HDPE is at most 4500 psi or at most 4000 psi or at most 3850 psi.

In some embodiments, the flexural modulus of the virgin bimodal HDPE is at least 100 ksi or at least 130 ksi or at least 145 ksi. In some embodiments, the flexural modulus of the virgin bimodal HDPE is at most 200 ksi or at most 180 ksi or at most 170 ksi. (1 ksi=1000 psi.)

In some embodiments, the viscosity of the virgin bimodal HDPE at a shear rate of 0.1 rad/s (“low shear viscosity” or “η_{0.1}”) is at least 40,000 pascal-seconds (Pa-s) or at least 60,000 Pa-s or at least 70,000 Pa-s. In some embodiments, the viscosity of the virgin bimodal HDPE at a shear rate of 0.1 rad/s (“low shear viscosity” or “η_{0.1}”) is at most 100,000 Pa-s or at most 90,000 Pa-s or at most 80,000 Pa-s.

In some embodiments, the viscosity of the virgin bimodal HDPE at a shear rate of 100 rad/s (“high shear viscosity” or “η₁₀₀”) is at least 1220 Pa-s or at least 1250 Pa-s or at least 1300 Pa-s. In some embodiments, the viscosity of the virgin bimodal HDPE at a shear rate of 100 rad/s (“high shear viscosity” or “η₁₀₀”) is at most 1500 Pa-s or at most 1450 Pa-s or at most 1400 Pa-s.

In some embodiments, the ratio of low shear viscosity to high shear viscosity (η_{0.1}/η₁₀₀) for the virgin bimodal HDPE is at least 30 or at least 40 or at least 45 or at least 50. In some embodiments, the ratio of low shear viscosity to high shear viscosity (η_{0.1}/η₁₀₀) for the virgin bimodal HDPE is at most 100 or at most 80 or at most 70 or at most 60.

Die swell of polymers can be compared using a “timed swell test” as described in PCT Publication WO 2020/223191 at Paragraph [0074]. The polymers are extruded through a specific die having a set aperture under a specific set of conditions (temperature, extrusion rate, shear, etc.), and the time required for the extrudate to reach a specified length is recorded. Polymer that swells more out of the die takes longer to reach the specified length and therefor has more die swell. In this application, the specified length is 25.4 cm.

In some embodiments, the timed die swell of the virgin bimodal HDPE under the test conditions listed below at a shear rate of 300 s⁻¹ is at least 23 seconds or at least 24 seconds or at least 25 seconds In some embodiments, the timed die swell of the virgin bimodal HDPE under the test conditions listed below at a shear rate of 300 s⁻¹ is at most 30 seconds or at most 28 seconds or at most 27 seconds or at most 26 seconds.

In some embodiments, the timed die swell of the virgin bimodal HDPE under the test conditions listed below at a shear rate of 1000 s is at least 7.5 seconds or at least 8.0 seconds or at least 8.3 seconds. In some embodiments, the timed die swell of the virgin bimodal HDPE under the test conditions listed below at a shear rate of 1000 s⁻¹ is at most 10.0 seconds or at most 9.5 seconds or at most 9.0 seconds.

In some embodiments, the ESCR (time to 50% failure rate under the test conditions listed below) of the virgin bimodal HDPE is at least 100 hours or at least 200 hours or at least 300 hours or at least 350 hours or at least 400 hours or at least 500 hours. There is no maximum desirable ESCR performance, but ESCR over 1000 hours may be unnecessary.

In some embodiments, the NCLS (time to 50% failure rate under the test conditions listed below) of the virgin bimodal HDPE is at least 50 hours or at least 75 hours or at least 100 hours or at least 150 hours or at least 200 hours or at least 300 hours or at least 500 hours. There is no maximum desirable NCLS performance, but NCLS over 1000 hours may be unnecessary.

In some embodiments the virgin bimodal HDPE copolymer comprises from 22.0 weight percent (wt %) to 29.9 wt % of a higher molecular weight ethylene/1-hexene copolymer component (HMW copolymer component) and from 78.0 wt % to 70.1 wt %, respectively, of a lower molecular weight ethylene/1-hexene copolymer component (LMW copolymer component), wherein the wt % of the HMW copolymer component and the wt % of the LMW copolymer component are based on the total weight of the HMW and LMW components. The weight percent of the HMW component is sometimes called a “split” of the virgin bimodal HDPE copolymer.

A particularly useful virgin bimodal HDPE copolymer comprises from 22.5 weight percent (wt %) to 29.4 wt % of a higher molecular weight ethylene/1-hexene copolymer component (HMW copolymer component) and from 77.5 wt % to 70.6 wt %, respectively, of a lower molecular weight ethylene/1-hexene copolymer component (LMW copolymer component), and wherein the virgin bimodal HDPE has each of properties (a) to (g): (a) a density from 0.940 g/cc to 0.956 g/cc; (b) a flow index (I₂₁) from 25.0 g/10 min. to 40.0 g/10 min.; (c) a ratio of Abs Mw/Mn from 12 to 14 or a ratio of Abs Mz/Mw of 7.0 to 8.0 or both ratios, wherein Mw is weight-average molecular weight and Mn is number-average molecular weight and Mz is z-average molecular weight, all measured by Absolute (“Abs”) Gel Permeation Chromatography (GPC); (d) a melt strength of at least 9 centinewtons (cN), measured at 190 °C by Melt Strength Test Method; (e) a ratio of low shear viscosity to high shear viscosity (η_{0.1}/η₁₀₀) from 40 to 100, measured according to Shear Viscosity Determination Method; (f) an environmental stress cracking resistance (ESCR) greater than 300 hours, measured according to ASTM D1693-15, Method B (10% Igepal, F50); and (g) wherein the wt % of the HMW copolymer component and the wt % of the LMW copolymer component are based on the total weight of the HMW and LMW components. In some embodiments this virgin bimodal high-density polyethylene has a timed die swell (time to reach 25.4 cm diameter) at a shear rate of 300 per second (s⁻¹) from 8.0 seconds to 9.5 seconds. In some such embodiments the virgin bimodal HDPE copolymer has a split of 23.5 wt % to 25.4 wt % of the HMW component, and consequently has from 76.5 wt % to 74.6 wt % of the LMW component. In other such embodiments the virgin bimodal HDPE copolymer has a split of 28.0 wt % to 29.4 wt % of the HMW component, and consequently from 72.0 wt % to 70.6 wt % of the LMW component.

The relative terms “higher” and “lower” in HMW and LMW are used in reference to each other and merely mean that the weight-average molecular weight of the HMW component (M_{w-HMW}) is greater than the weight-average molecular weight of the LMW component (M_{w-LMW}), i.e., M_{w-HMW}>M_{w-LMW}.

Embodiments of the present invention also include the virgin bimodal HDPE, such as the particularly useful virgin bimodal HDPE copolymer described in the immediately preceding paragraph.

Some species of the virgin bimodal HDPE polymer may be easier to produce using a single reactor with such a bimodal catalyst system. The virgin bimodal HDPE polymer is a so-called reactor copolymer because it is made in a single polymerization reactor using a bimodal catalyst system effective for simultaneously making the HMW and LMW copolymer components in situ.

In addition the being useful in HDPE blends with recycled polymer, this bimodal HDPE copolymer is useful as the sole polymer for blow-molding applications. It has good melt-strength, crack resistance and other physical properties. Narrower specific embodiments may optionally be as previously described for the virgin bimodal HDPE.

Virgin bimodal high-density polyethylenes and processes for their manufacture are described in numerous references such as the following patent applications: US 2007/0043177 A1; US 2009/0036610 A1; US 2020/0071509 A1, WO 2009/148487 A1, WO 2019/241045 A1, WO 2020/046663 At, and WO 2020/068413 A1; and the following patents: U.S. Pat. Nos. 5,539,076; 5,882,750; 6,403,181 B1; 7,090,927; 8,110,644 B2; and 8,378,029 B2 and Publication B5845, Bimodal Molecular Weight Polyethylene for Blow Molding, issued by Total Petrochemicals USA, Inc. Some production techniques use dual sequential reactors, and some production techniques use a single reactor with a bimodal catalyst system. Suitable bimodal catalyst systems are commercially available from Univation Technologies, LLC.

An example of a suitable bimodal catalyst system is the bimodal catalyst system provided under the PRODIGY™ BMC 300 trademark or can be produced as described in the patents above and in US Application 2020/0024376 A1. The PRODIGY™ BMC 300 catalyst system comprises, or is made from, a zirconium-containing metallocene catalyst, a zirconium-containing post-metallocene catalyst, a support material, and an activator. The zirconium-containing metallocene catalyst is bis(n-butylcyclopentadienyl)zirconium X₂ of formula (I):

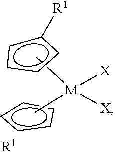

wherein each R¹ is —CH₂CH₂CH₂CH₃ and each X is a leaving group. In some embodiments of formula (I) each X is Cl or each X is methyl. The zirconium-containing post-metallocene catalyst is bis(2-(pentamethylphenylamido)ethyl)amine zirconium dibenzyl, which is sometimes referred to in the art as “HN5 dibenzyl” and is a compound of formula (II)

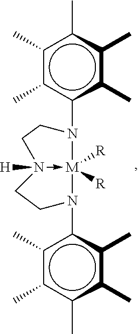

wherein M is Zr and each R is benzyl (“Bn”). Both catalysts are well known in the art. For example, the zirconium-containing post-metallocene catalyst may be made by procedures described in the art or obtained from Univation Technologies, LLC, Houston, Texas, USA, a wholly-owned entity of The Dow Chemical Company, Midland, Michigan, USA. Representative Group 15-containing metal compounds, including bis(2-(pentamethylphenylamido)ethyl)amine zirconium dibenzyl, and preparation thereof can be as discussed and described in U.S. Pat. Nos. 5,318,935; 5,889,128; 6,333,389; 6,271,325; 6,689,847; and 9,981,371; and WO Publications WO 99/011460; WO 98/46651; WO 2009/064404: WO 2009/064452; and WO 2009/064482.

The PRODIGY™ BMC-300 embodiment of the bimodal catalyst system was used to make virgin bimodal HDPE polymer number 1, called “Virgin Bimodal HDPE 1” in the EXAMPLES.

Another suitable embodiment of the bimodal catalyst system is made from the same constituents as used to make the BMC-300 type catalyst system except wherein the bis(n-butylcyclopentadienyl)zirconium X₂ of formula (I) is replaced by (cyclopentadienyl)(1,5-dimethylindenyl)zirconium X₂, which is a zirconium-containing metallocene of formula (III):

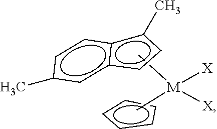

wherein M is Zr and each X is a leaving group. In some embodiments of formula (III) each X is Cl or each X is methyl. This other suitable bimodal catalyst system thus comprises, or is made from, the zirconium-containing metallocene of formula (III), the HN5 dibenzyl, the support, and an activator. For convenience herein, this other embodiment of the bimodal catalyst system is called “BMC Analog”.

The BMC Analog embodiment of the bimodal catalyst system was used to make virgin bimodal HDPE polymer number 2, called “Virgin Bimodal HDPE 2” in the EXAMPLES.

The support material used in these bimodal catalyst systems may be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 20 to 300 micrometers (m). Alternatively, the pore volume is from 0.5 to 6.0 cubic centimeters per gram (cc/g) and the surface area is from 200 to 600 m²/g. Alternatively, the pore volume is from 1.1 to 1.8 cc/g and the surface area is from 245 to 375 m²/g. Alternatively, the pore volume is from 2.4 to 3.7 cc/g and the surface area is from 410 to 620 m²/g. Alternatively, the pore volume is from 0.9 to 1.4 cc/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, such as the HN5 dibenzyl and the zirconium-containing metallocene, the support material may be pre-treated by heating the support material in air to give a calcined support material. The pre-treating comprises heating the support material at a peak temperature from 350° to 850 °C, alternatively from 400° to 800 °C, alternatively from 400° to 700 °C, alternatively from 500° to 650 °C and for a time period from 2 to 24 hours, alternatively from 4 to 16 hours, alternatively from 8 to 12 hours, alternatively from 1 to 4 hours, thereby making a calcined support material. The support material may be a calcined support material.

The method of making the virgin bimodal HDPE using the bimodal catalyst system may further employ a trim catalyst, typically in the form of a trim catalyst solution comprising the aforementioned zirconium-containing metallocene of formula (I) or (III) and an additional quantity of activator. For convenience the trim catalyst is fed in solution in a hydrocarbon solvent (e.g., mineral oil, heptane, or isopentane). The trim catalyst may be used to vary, within limits, the amount of the zirconium-containing metallocene used in the method relative to the amount of the zirconium-containing post-metallocene (e.g., HN5 dibenzyl) of the bimodal catalyst system, so as to adjust the properties of the inventive HDPE blend.

Each catalyst of the bimodal catalyst system is activated by contacting it with an activator. Any activator may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Zr) may be 1000:1 to 0.5:1, alternatively 300:1 to 1:1, alternatively 150:1 to 1:1. Suitable activators are commercially available.

Once the activator and the catalysts of the bimodal catalyst system contact each other, the catalysts of the bimodal catalyst system are activated and activator species may be made in situ. The activator species may have a different structure or composition than the catalyst and activator from which it is derived and may be a by-product of the activation of the catalyst or may be a derivative of the by-product. The corresponding activator species may be a derivative of the Lewis acid, non-coordinating ionic activator, ionizing activator, Lewis base, alkylaluminum, or alkylaluminoxane, respectively. An example of the derivative of the by-product is a methylaluminoxane species that is formed by devolatilizing during spray-drying of a bimodal catalyst system made with methylaluminoxane.

Each contacting step between activator and catalyst independently may be done either in a separate vessel outside of a gas phase polymerization (GPP) reactor, such as outside of a floating-bed gas phase polymerization (FB-GPP) reactor, or in a feed line to the GPP reactor. The bimodal catalyst system, once its catalysts are activated, may be fed into the GPP reactor as a dry powder, alternatively as a slurry in a non-polar, aprotic (hydrocarbon) solvent. The activator(s) may be fed into the GPP reactor in “wet mode” in the form of a solution thereof in an inert liquid such as mineral oil or toluene, in slurry mode as a suspension, or in dry mode as a powder. Each contacting step may be done at the same or different times.

The gas phase polymerization reactor may be a fluidized-bed gas phase polymerization (FB-GPP) reactor and the effective polymerization conditions may comprise the following reaction conditions: the FB-GPP reactor having a fluidized bed at a bed temperature from 80 to 110 degrees Celsius (°C); the FB-GPP reactor receiving feeds of respective independently controlled amounts of ethylene, 1-alkene characterized by a 1-alkene-to-ethylene (Cₓ/C₂, wherein subscript x indicates the number of carbon atoms in the 1-alkene; for example, when the 1-alkene is 1-hexene, the Cₓ/C₂ ratio is the 1-hexene-to-ethylene ratio, which may be written as a C₆/C₂ ratio) molar ratio, the bimodal catalyst system, optionally a trim catalyst solution, optionally hydrogen gas (H₂) characterized by a hydrogen-to-ethylene (H₂/C₂) molar ratio or by a weight parts per million H₂ to mole percent C₂ ratio (H₂ ppm/C₂ mol %), and optionally an induced condensing agent (ICA) comprising a (C₅-C₁₀)alkane(s), e.g., isopentane; wherein the (C₆/C₂) molar ratio is from 0.0010 to 0.1; and wherein when the ICA is fed, the concentration of ICA in the reactor is from 1 to 20 mole percent (mol %), based on total moles of ethylene, 1-alkene, and ICA in the reactor. The average residence time of the copolymer in the reactor may be from 1.0 to 4.0 hours. A continuity additive may be used in the FB-GPP reactor during polymerization.

In some embodiments the reaction conditions are those described in the EXAMPLES for making Virgin Bimodal HDPE 1 or Virgin Bimodal HDPE 2, plus-or-minus (±) 10%.

### HDPE Blends

The HDPE blend is a post-reactor blend of the recycled HDPE and the virgin bimodal HDPE.

In HDPE blends of the present invention, the recycled HDPE and the virgin bimodal HDPE are melt-blended together in a relative amount of from 25 to 90 weight percent recycled HDPE and from 10 to 75 weight percent virgin bimodal HDPE. The blending can be accomplished by any known means, such as coextruding the two polymers in known extruders or melt blending in known mixers such as from Hakke, Brabender or Banbury.

In some embodiments, the HDPE blend contains at least 35 weight percent recycled HDPE or at least 45 weight percent or at least 55 weight percent or at least 65 weight percent or at least 70 weight percent or at least 75 weight percent or at least 80 weight percent. In some embodiments, the HDPE blend contains at most 85 weight percent recycled HDPE or at most 80 weight percent or at most 75 weight percent or at most 65 weight percent or at most 55 weight percent. For example, the HDPE blend may contain 45 to 80 weight percent recycled HDPE, or 45 to 65 weight percent, or 65 to 80 weight percent, or 70 to 90 weight percent.

In some embodiments, the HDPE blend contains at most 65 weight percent virgin bimodal HDPE or at most 55 weight percent or at most 45 weight percent or at most 35 weight percent or at most 30 or at most 25 weight percent or at most 20 weight percent weight percent. In some embodiments, the HDPE blend contains at least 15 weight percent virgin bimodal HDPE or at least 20 weight percent or at least 25 weight percent or at least 35 weight percent or at least 45 weight percent. For example, the HDPE blend may contain 20 to 55 weight percent virgin bimodal HDPE, or 35 to 55 weight percent, or 20 to 35 weight percent, or 10 to 30 weight percent.

In some embodiments, the HDPE blend may contain additives. Additives for polyolefin polymers are described in numerous publications, such as the pamphlet: Tolinski, “Additives for Polyolefins. Getting the Most out of Polypropylene, Polyethylene and TPO (Second Edition)” published by the Plastics Design Library in 2015. Examples of common additives include antistatic agents, color enhancers, dyes, lubricants, fillers, pigments, primary antioxidants, secondary antioxidants, processing aids, UV stabilizers, nucleators, slip agents such as erucamide, antiblock agents such as talc, and combinations thereof. In some embodiments, additives make up no more than 5 weight percent of the HDPE blend or no more than 4 weight percent or no more than 3 weight percent or no more than 2 weight percent or no more than 1 weight percent. In some embodiments, additives make up essentially 0 weight percent of the HDPE blend.

In some embodiments, the density of the HDPE blend is at least 0.94 g/cc or at least 0.945 g/cc or at least 0.95 g/cc or at least 0.955 g/cc or at least 0.957 g/cc. In some embodiments, the density of the HDPE blend is at most 0.97 g/cc or at most 0.965 g/cc or at most 0.963 g/cc or at most 0.961 g/cc or at most 0.96 g/cc.

In some embodiments, the melt index (I₂) of the HDPE blend is at least 0.1 g/10 min or at least 0.15 g/10 min or at least 0.16 g/10 min or at least 0.17 g/10 min. In some embodiments, the melt index (I₂) of the HDPE blend is at most 2 g/10 min or at most 1 g/10 min or at most 0.8 g/10 min or at most 0.7 g/10 min or at most 0.6 g/10 min or at most 0.5 g/10 min.

In some embodiments, the flow index (I₂₁) of the HDPE blend is at least 20 g/10 min or at least 25 g/10 min or at least 28 g/10 min or at least 30 g/10 min or at least 31 g/10 min. In some embodiments, the flow index (I₂₁) of the HDPE blend is at most 90 g/10 min or at most 80 g/10 min or at most 70 g/10 min or at most 60 g/10 min or at most 58 g/10 min or at most 56 g/10 min.

In some embodiments, the melt flow ratio (I₂₁/I₂) of the HDPE blend is at least 15 or at least 18 or at least 20 or at least 21. In some embodiments, the melt flow ratio (I₂₁/I₂) of the HDPE blend is at most 45 or at most 40 or at most 36 or at most 34 or at most 32.

In some embodiments, the tensile yield strength of the HDPE blend is at least 3000 psi or at least 3500 psi or at least 3700 psi or at least 3900 psi or at least 4000 psi or at least 4100 psi. In some embodiments, the tensile yield strength of the HDPE blend is at most 7000 psi or at most 6000 psi or at most 5000 psi or at most 4500 psi.

In some embodiments, the flexural modulus of the HDPE blend is at least 130 ksi or at least 140 ksi or at least 150 ksi or at least 155 ksi or at least 160 ksi or at least 170 ksi. In some embodiments, the flexural modulus of the HDPE blend is at most 200 ksi or at most 180 ksi or at most 175 ksi. (1 ksi=1000 psi.)

In some embodiments, the ESCR (time to 50% failure rate under the test conditions listed below) of an HDPE blend that contains at least 45 weight percent recycled HDPE is at least 30 hours or at least 40 hours or at least 50 hours or at least 60 hours or at least 70 hours or at least 80 hours. In some embodiments, the ESCR (time to 50% failure rate under the test conditions listed below) of an HDPE blend that contains at least 70 weight percent recycled HDPE is at least 15 hours or at least 20 hours or at least 22 hours or at least 25 hours. There is no maximum desired ESCR, but performance over 100 or 200 hours may be unnecessary.

In some embodiments, the Notched Constant Ligament Stress (time to 50% failure rate under the test conditions listed below) of an HDPE blend that contains at least 45 weight percent recycled HDPE is at least 30 hours or at least 40 hours or at least 50 hours or at least 60 hours or at least 70 hours or at least 80 hours. In some embodiments, the NCLS (time to 50% failure rate under the test conditions listed below) of the HDPE blend that contains at least 70 weight percent recycled HDPE is at least 15 hours or at least 21 hours or at least 25 hours or at least 27 hours. There is no maximum desired NCLS, but performance over 100 or 200 hours may be unnecessary.

In some embodiments, the Charpy impact resistance of the HDPE blend is at least 3.5 kJ/m² or at least 4 kJ/m² or at least 4.5 kJ/m² or at least 4.8 kJ/m² or at least 5 kJ/m² or at least 5.5 kJ/m² or at least 6 kJ/m² or at least 6.5 kJ/m². There is no maximum desired Charpy Impact resistance, but performance over 10 kJ/m² may be unnecessary.

In some embodiments, the strain hardening modulus of the HDPE blend is at least 6 MPa or at least 8 MPa or at least 9 MPa or at least 11 MPa or at least 13 MPa or at least 15 MPa or at least 17 MPa or at least 18 MPa. In some embodiments, the strain hardening modulus of the HDPE blend is at most 20 MPa or at most 16 MPa or at most 13 MPa or at most 4500 psi.

In some embodiments, the melt strength of the HDPE blend that contains at least 45 weight percent of the recycled HDPE is at least 8.0 cN or at least 8.5 cN or at least 9 cN. In some embodiments, the melt strength of the HDPE blend that contains at least 45 weight percent of the recycled HDPE is at most 12 cN or at most 10 cN.

In some embodiments, the melt strength of the HDPE blend that contains at least 70 weight percent of the recycled HDPE is at least 7.0 cN or at least 7.5 cN or at least 8 cN. In some embodiments, the melt strength of the HDPE blend that contains at least 70 weight percent of the recycled HDPE is at most 10 cN or at most 9 cN.

### Blow Molding and Fabricated Articles

HDPE blends of the present invention can be used in common blow molding processes, such as extrusion blow-molding, injection blow molding or injection stretch blow molding. All three processes use the following steps: (1) placing a quantity of molten HDPE blend in a mold cavity, (2) blowing air or a neutral gas such as nitrogen into the molten HDPE blend, causing it to expand and assume the approximate shape of the mold cavity, and (3) cooling the HDPE blend.

In an extrusion blow molding process, the HDPE blend is melted and extruded as a hollow tube, called a parison. The parison is enclosed in a cooled metal mold for a shaped article such as a bottle, container, or part. Air or a neutral gas such as nitrogen is then blown into the parison, inflating it into the shape of the mold. After the HDPE blend has cooled sufficiently, the mold is opened, and the part is ejected.

In an injection blow molding process, the HDPE blend is melted and injected into a metal mold for a shaped article such as a bottle, container, or part. Air or a neutral gas such as nitrogen is then blown into the mold, inflating the HDPE blend into the shape of the mold. After the HDPE blend has cooled sufficiently, the mold is opened, and the part is ejected.

In an injection stretch blow molding process, a preform of the HDPE blend is made by injection molding. In some embodiments, the final neck features for the final molded item (such as threading on a bottle neck) are made on the preform. Next, the molten preform is placed in a mold. Air or a neutral gas such as nitrogen is then blown into the preform, inflating it into the shape of the mold. After the HDPE blend has cooled sufficiently, the mold is opened, and the part is ejected. The preform may be blown immediately after it is formed, or it may be cooled and then reheated and blown later.

In some embodiments, the temperature of the molten HDPE blend is at least 150 °C or at least 155 °C or at least 160 °C. In some embodiments, the temperature of the molten HDPE blend is at most 210 °C or at most 190 °C or at most 180 °C.

The product of the blow-molding is a shaped article. In some embodiments, the shaped article is a liquid container, such as a jar or bottle. In some embodiments, the liquid container has a capacity of at most 10 L or at most 5 L or at most 2 L or at lost 1 L or at most 0.75 L or at most 0.5 L or at most 0.4 L or at most 0.3 L. In some embodiments, the liquid container has a capacity of at least 0.1 L or at least 0.3 L or at least 0.5 L or at least 0.75 L or at least 1 L. In some embodiments, the liquid container is smaller, having a capacity from 1 to 100 mL.

Equipment for blow molding is commercially available. Blow molding procedures are well-known described in numerous publications such as “Blow Molding Design Guide”, published by Gemini Group at https://geminigroup.net/wp-content/uploads/2018/06/Blow-Molding-Design-Guide-by-Regency-Plastics.pdf, “Blow-Molding”, published by Industrial Quick Search at https://www.iqsdirectory.com/articles/blow-molding.html, “A Guide to Polyolefin Blow Molding”, Publication 6683/0715 published by LyondellBasell Industries, and N. C. Lee, Understanding Blow Molding (Hanser Publications, 2007).

In some embodiments the high-density polyethylene blend comprises: (a) from 25 to 90 weight percent of a recycled high-density polyethylene; and (b) from 10 to 75 weight percent of a virgin bimodal high-density polyethylene having a density from 0.940 gram per cubic centimeter (g/cc) to 0.956 g/cc and a flow index (121) from 25 grams per 10 minutes (g/10 min.) to 40 g/10 min.

In some embodiments the recycled high-density polyethylene is a post-consumer recycled polymer.

In some embodiments the virgin bimodal high-density polyethylene has a density from 0.945 g/cc to 0.955 g/cc.

In some embodiments the virgin bimodal high-density polyethylene has a flow index (I₂₁) from 28 g/10 min to 35 g/10 min.

In some embodiments the virgin bimodal high-density polyethylene has a timed die swell (time to reach 25.4 cm diameter) at a shear rate of 300 per second (s⁻¹) from 23 seconds to 30 seconds.

In some embodiments the high-density polyethylene blend has a density from 0.950 g/cc to 0.965 g/cc, or a flow index (I₂₁) from 28 g/10 min. to 60 g/10 min., or both properties.

In some embodiments the high-density polyethylene blend contains at least 45 weight percent of the recycled high-density polyethylene. In some embodiments the high-density polyethylene blend also has an ESCR of at least 30 hours as measured according to ASTM D 1693-13, Condition B, with at 10% surfactant in water; or which has a melt strength of at least 8.5 cN; or which has the ESCR of at least 30 hours and the melt strength of at least 8.5 cN.

In some embodiments the high-density polyethylene blend contains at least 70 weight percent recycled high-density polyethylene. In some embodiments the high-density polyethylene blend also has an NCLS of at least 21 hours as measured according to ASTM F2136; or which has a melt strength of at least 7.5 cN; or which has the NCLS of at least 21 hours and the melt strength of at least 7.5 cN.

In some embodiments the virgin bimodal high-density polyethylene (HDPE) copolymer comprises from 22.5 weight percent (wt %) to 29.4 wt % of a higher molecular weight HDPE copolymer component (HMW copolymer component) and from 77.5 wt % to 70.6 wt %, respectively, of a lower molecular weight HDPE copolymer component (LMW copolymer component), wherein the copolymer has each of properties (a) to (g): (a) a density from 0.940 g/cc to 0.956 g/cc; (b) a flow index (I₂₁) from 25.0 g/10 min. to 40.0 g/10 min.; (c) a ratio of Mw/Mn from 12 to 18, wherein Mw is weight-average molecular weight and Mn is number-average molecular weight, both measured by Conventional Gel Permeation Chromatography (GPC); (d) a melt strength of at least 9 centinewtons (cN), measured at 190 °C by Melt Strength Test Method; (e) the ratio of low shear viscosity to high shear viscosity (η_{0.1}/η₁₀₀) from 40 to 100, measured according to Shear Viscosity Determination Method; (f) an environmental stress cracking resistance (ESCR) greater than 300 hours, measured according to ASTM D1693-15, Method B (10% Igepal, F50); and (g) a timed die swell (time to reach 25.4 cm diameter) at a shear rate of 300 per second (s⁻¹) from 23 seconds to 27 seconds or a timed die swell (time to reach 25.4 cm diameter) at a shear rate of 1000 s⁻¹ of 8.3 to 8.8 seconds or both; and wherein the wt % of the HMW copolymer component and the wt % of the LMW copolymer component are based on the total weight thereof. In some embodiments the shaped article, such as the blow molded article, comprises this high-density polyethylene blend.

### Test Methods:

The following test methods are used to measure properties described in this application:

Density: Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cc).

Differential Scanning Calorimetry (DSC): Differential scanning calorimetry (DSC) is a common technique that can be used to examine the melting and crystallization of semi-ciystalline polymers. General principles of DSC measurements and applications of DSC to studying semi-crystalline polymers are described in standard texts (e.g., E. A. Turi, ed., Thermal Characterization of Polymeric Materials, Academic Press, 1981).

In preparation for Differential Scanning Calorimetry (DSC) testing, pellet-form samples are first loaded into a 1 in. diameter chase of 0.13 mm thickness and compression molded into a film under 25,000 lbs. of pressure at 190 °C for approximately 10 seconds. The resulting film is then cooled to room temperature, after which the film is subjected to a punch press in order to extract a disk that will fit the aluminum pan supplied by TA Instruments. The disk is then weighed individually (note: sample weight is approximately 4-8 mg) and placed into the aluminum pan and sealed before being inserted into the DSC test chamber.

In accordance with ASTM standard D3418, the DSC test is conducted using a heat-cool-heat cycle. First, the sample is equilibrated at 180 °C and held isothermally for 5 min to remove thermal and process history. The sample is then quenched to −40 °C at a rate of 10 °C/min and held isothermally once again for 5 min during the cool cycle. Lastly, the sample is heated at a rate of 10 °C/min to 150 °C for the second heating cycle. For data analysis, the melting temperatures and enthalpy of fusion is extracted from the second heating curve, whereas the enthalpy of crystallization is taken from the cooling curve. The enthalpy of fusion and crystallization were obtained by integrating the DSC thermogram from −20 °C to the end of melting and crystallization, respectively. The tests are performed using the TA Instruments Q2000 and Discovery DSCs, and data analyses were conducted via TA Instruments Universal Analysis and TRIOS software packages.

Melt Index, Flow Index and Melt Flow Ratio: Flow index (I₂₁) is measured according to ASTM D1238-13, Condition 190 °C/21.6 kg, and is reported in g/10 min. Melt index I₅ and I₂ are measured following the same procedure using 5.0 kg and 2.16 kg load conditions, respectively. Melt Flow Ratio (I₂₁/I₅) is calculated based on the results.

Melt Strength: Melt Strength testing is conducted on either Rheotester 2000 or Rheograph 25 capillary rheometers paired with a Rheotens model 71.97, all of which are manufacture by Göttfert. The die used for testing has a diameter of 2 mm, length of 30 mm, and an entry angle of 180 degrees. Each test is performed isothermally at 190 °C. Prior to initiating the test, the sample pellets are loaded into the capillary barrel and allowed to equilibrate at the testing temperature for 10 min. During the test, a piston inside the barrel applies a steady force on the molten sample to achieve an apparent wall shear rate of 38.16 s⁻¹, and the melt is extruded through the die with an exit velocity of approximately 9.7 mm/second. Located 100 mm below the die exit, the extrudate in the form of a strand is guided through wheel pairs of the Rheotens, which accelerate at a constant rate of 2.4 mm/s² and measures the extrudate's response to the applied extensional force. Note that the Rheotens wheel pairs are typically serrated and are spaced 0.4 mm apart. The results of this test are documented into plots of force with respect to Rheotens wheel speed using the RtensEvaluations 2007 excel macros. In these plots, the force levels off, i.e., plateaus, before the extrudate strand breaks. For analysis, the melt strength is reported as the plateau force in centinewtons (cN) before the extrudate strand broke. The corresponding speed of the of the Rheotens wheel at the point of strand breakage is documented as the drawability limit.

Environmental Stress Crack Resistance (ESCR): ESCR measurements are conducted according to ASTM D1693-15, Standard Test Method for Environmental Stress-Cracking of Ethylene Plastics, Method B. ESCR (10% IGEPAL CO-630, F50) is the number of hours to failure of 50 percent of specimens of a bent, notched, compression-molded test specimen that is immersed in a solution of 10 weight percent IGEPAL CO-630 in water at a temperature of 50 °C. IGEPAL CO-630 is an ethoxylated branched-nonylphenol of structural formula 4-(branched-C9H19)-phenyl-[OCH₂CH₂]ₙ—OH, wherein subscript n is a number such that the branched ethoxylated nonylphenol has a number-average molecular weight of about 619 grams/mole.

Notched Constant Ligament Stress (NCLS): NCLS is measured using ASTM F2136.

Charpy Impact Resistance: Charpy impact strength is tested at −40 °C according to ISO 179, Plastics—Determination of Charpy Impact Properties. Specimens that have the dimensions 80 mm×10 mm×4 mm are cut and machined from a 4 mm compression molded plaque that has been cooled at 5 °C/minute. The specimens are notched on their long sides in the thickness direction to a depth of 2 mm using a notching device with a 22.5 degree half-angle and a 0.25 radius curvature at its tip. Specimens are cooled in a cold box for 1 hour then removed and tested in less than 5 seconds. The impact tester meets the specification described in ISO 179. Results are reported in units of kilojoules per square meter (kJ/m2).

2% Secant Flexural Modulus: Is measured according to ASTM D790-10, Procedure B, Standard Test Methods for Flexural Properties of Unreinforced and Reinforced Plastics and Electrical Insulating Materials. Results are reported in megapascals (MPa). 1,000.0 pounds per square inch (psi)=6.8948 MPa.

Tensile Strength: Tensile Strength is measured using ASTM D638-14. The average of five specimens tested at a speed of 2 in/min is reported.

Strain Hardening Modulus: The ISO 18488 standard is followed to determine strain hardening modulus (“SHM”). Polymer pellets are compression molded into sheets of 0.3 mm thickness following molding conditions described in Table 1 of the ISO 18488 standard. After molding, the sheets are conditioned at 120 °C for one hour followed by controlled cooling at a rate of 2 °C/min to room temperature. Five tensile bars (dog bone shaped) are punched out of the compression molded sheets. The tensile test is conducted in a temperature chamber at 80 °C. Each specimen is conditioned for at least 30 minutes in the temperature chamber prior to starting the test. The test specimen is clamped top and bottom and a pre-load of 0.4 MPa with a speed of 5 mm/min is applied. During the test, the load and the elongation sustained by the specimen are measured. The test specimen is extended at a constant speed of 20 mm/min and data point are collected from a draw ratio (λ) of 8.0 until λ=12.0 or breakage. As specified in ISO 18488, the plot of true stress vs. draw ratio is used to calculate the slope between a draw ratio of 8.0 and 12.0. If failure occurred before a draw ratio of 12.0, then the draw ratio corresponding to the failure strain is considered as upper limit for the slope calculation. If failure occurred before a draw ratio of 8.0, then the test is considered invalid.

Die Swell: Polymer swell is characterized in terms of “timed swell” by a capillary rheometer. In this approach, the time required for an extruded polymer strand to travel a distance of 10 in. (25.4 cm) is determined. The more the polymer swells, the slower the free end of the strand travels, and the longer it takes to cover the distance. A 12 mm barrel Göttfert Rheotester 2000 equipped with a 30/1 (mm/mm) L/D capillary die is used for the measurement. The measurement is carried out at 190 °C at two fixed shear rates: 300 s⁻¹ and 1000 s⁻¹. The time measure of swell is reported as the t300 and t1000 values, respectively.

High Shear and Low Shear Viscosity: Dynamic oscillatory shear measurements are conducted over a range of 0.1 rad s-1 to 100 rad s-1 at a temperature of 190 °C and 10% strain with stainless steel parallel plates of 25 mm diameter on the strain controlled rheometer ARES/ARES-G2 by TA Instruments. The rheometer is preheated for at least 30 minutes at 190 °C. Place the disk prepared by the Compression Molded Plaque Preparation Method between two “25 mm” parallel plates in the oven. Slowly reduce the gap between the “25 mm” parallel plates to 2.0 mm. Allow the sample to remain for exactly 5 minutes at these conditions. Open the oven, and carefully trim excess sample from around the edge of the plates. Close the oven. Allow an additional 5-minute delay to allow for temperature equilibrium. Then determine the complex shear viscosity via a small amplitude, oscillatory shear, according to an increasing frequency sweep from 0.1 to 100 rad/s to obtain the complex viscosities at 0.1 rad/s and 100 rad/s. Define the shear viscosity ratio (SVR) as the ratio of the complex shear viscosity in pascal-seconds (Pa·s) at 0.1 rad/s to the complex shear viscosity in pascal-seconds (Pa·s) at 100 rad/s.

### Molecular Weights (Determined by Gel Permeation Chromatography (GPC)):

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 160° Celsius and the column and detector compartment were set at 1500 Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80 °C with gentle agitation for 30 minutes then cooled and the room temperature solution is transferred cooled into the autosampler dissolution oven at 160 °C for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} (EQ1)
where M is the molecular weight, A has a value of 0.4389 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mn}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

Flowrate(effective)=Flowrate(nominal)*(RV(FM Calibrated)/RV(FM Sample)) (EQ5)

### Triple Detector GPC (TDGPC)

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are be calculated according to equations 8-10 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ 8 )$$

$$Mw ( Abs ) = \frac{{\sum }^{i} {IR}_{i} \times {M}_{{Absolute}_{i}}}{{\sum }^{i} {IR}_{i}} \qquad ( EQ 9 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} . \qquad ( EQ 10 )$$

### EXAMPLES

The following working examples illustrate some specific embodiments of the invention but do not limit the broad scope of the invention.

### Production of Virgin Bimodal HDPE Polymers

Virgin Bimodal HDPE 1 is an embodiment of the virgin bimodal HDPE polymer made using ethylene (“C₂”) monomer and 1-hexene (“C₆”) comonomer and PRODIGY™ BMC-300 bimodal catalyst system from Univation Technologies, LLC. Virgin Bimodal HDPE 2 is another embodiment of the virgin bimodal HDPE polymer made using ethylene (“C₂”) monomer and 1-hexene (“C₆”) comonomer and BMC Analog bimodal catalyst system, described earlier. Each of Virgin Bimodal HDPE 1 and Virgin Bimodal HDPE 2 independently comprises a higher molecular weight component that is an ethylene/1-hexene copolymer and a lower molecular weight constituent that is an ethylene/1-hexene copolymer. Both Virgin Bimodal HDPEs 1 and 2 are made in a fluidized-bed gas phase polymerization (FB-GPP) reactor with an isopentane (“iC₅”) feed, under conditions shown in Table 1.

TABLE 1

| | Sample | |
|---|---|---|
| | Virgin Bimodal HDPE 1 | Virgin Bimodal HDPE 2 |
| | Bimodal Catalyst System | |
| | PRODIGY ™ BMC-300 | BMC Analog |
| Reactor Bed | 100 | 100 |
| Temperature (°C) | | |
| C₆/C₂ mol/mol ratio | 0.0017 | 0.0024 |
| H₂/C₂ mol/mol ratio | 0.0011 | 0.0011 |
| iC₅ mol % | 12.55 | 12.88 |

For comparative purposes, a virgin unimodal HDPE polymer that is commonly blended with recycled polyethylene (UNIVAL™ DMDA-6200 polyethylene from The Dow Chemical Company) is obtained.

Post-consumer recycled (PCR) HDPE homopolymer is obtained: KWR 101-150 natural homopolymer high-density polyethylene polymer from KW Plastic.

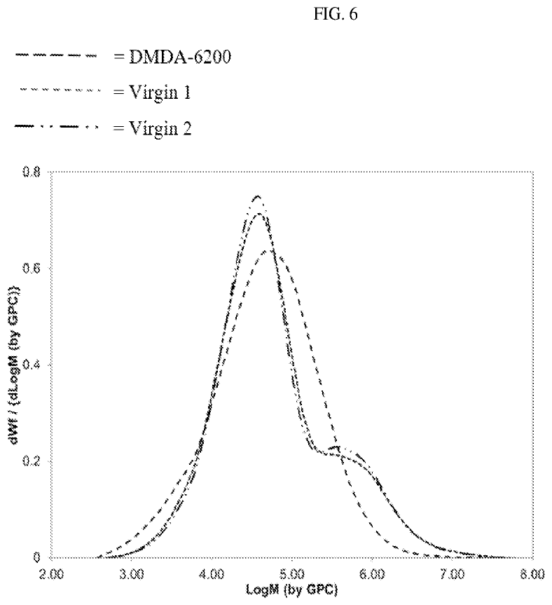

The properties of all four polymers are reported in Table 2. The molecular weight distributions for the three virgin HDPE polymers, as measured by gel permeation chromatography, are also illustrated in FIG. 6.

TABLE 2

| | Description | | | |
|---|---|---|---|---|
| | Virgin | Virgin | | |
| | Bimodal | Bimodal | DMDA- | PCR KWR- |
| | HDPE 1 | HDPE 2 | 6200 | 101-150 |
| | Type | | | |
| | Bimodal | Bimodal | Unimodal | Unimodal PCR |
| | Catalyst | | | |
| | BMC-300 | BMC Analog | Cr-based | Unknown |
| HMW PE (wt %) | 24.7 | 29.3 | N/a | N/a |
| LMW PE (wt %) | 75.3 | 70.7 | N/a | N/a |
| I₂ (g/10 min) | 0.171 | 0.132 | 0.331 | 0.629 |
| I₅ (g/10 min) | 1.164 | 0.928 | 1.548 | 2.923 |
| I₂₁ (g/10 min) | 32.5 | 30.2 | 31.3 | 56.66 |
| I₂₁/I₅ | 27.9 | 32.5 | 20.3 | 19.4 |
| Density (g/cc) | 0.953 | 0.953 | 0.953 | 0.961 |
| GPC Mn (g/mol) | 20,390 | 21,256 | 14,267 | 19,707 |
| GPC Mw (g/mol) | 328,469 | 325,965 | 140,161 | 114,840 |
| GPC Mw/Mn | 16.11 | 15.34 | 9.82 | 5.83 |
| GPC Mz (g/mol) | 5,463,186 | 5,266,485 | 1,966,339 | 580,136 |
| GPC Mz/Mw | 16.63 | 16.16 | 14.03 | 5.05 |
| Abs Mn (g/mol) | 18,627 | 19,670 | 13,447 | 18,626 |
| Abs Mw (g/mol) | 258,820 | 258,478 | 135,008 | 122,949 |
| Abs Mw/Mn | 13.9 | 13.1 | 10.0 | 6.6 |
| Abs Mz (g/mol) | 2,011,829 | 1,887,713 | 1,001,825 | 646,179 |
| Abs Mz/Mw | 7.77 | 7.30 | 7.42 | 5.25 |
| Die Swell (t 1000) | 8.7 | 8.4 | 7.3 | N/m |
| Die Swell (t 300) | 25.3 | 24.2 | 22.7 | N/m |
| Viscosity (η at 0.1 | 70185 | 77795 | 33907 | 25377 |
| rad/s) (Pa-s) | | | | |
| Viscosity (η at 100 | 1332 | 1398 | 1210 | 1018 |
| rad/s) (Pa-s) | | | | |
| η_{0.1}/η₁₀₀ | 53 | 56 | 28 | 25 |

In Table 2, the “GPC” molecular weight data were measured by the conventional GPC, the “Abs” molecular weight data were measured by the absolute GPC test method, N/a means not applicable, N/m means not measured, viscosity (11 at 0.1 rad/s) is low shear viscosity, and viscosity (η at 100 rad/s) is high shear viscosity.

In Table 2, the PCR grade used was KWR101-150 from KW Plastics and its properties shown in Table 2 were measured in Dow laboratories. The base polymers (Virgin Bimodal HDPE 1 and Virgin Bimodal HDPE 2 and DMDA-6200) contain 0.06 wt. % of Irganox-1010 antioxidant and 0.10 wt. % of Irgafos-168 antioxidant.

The PCR polymer is melt-blended with each of the virgin polymers in quantities of 25 weight percent PCR polymer, 50 weight percent PCR polymer, 75 weight percent PCR polymer and 90 weight percent PCR polymer to form HDPE blends.

The melt-blending is carried out on a Coperion ZSK 25 mm twin-screw extruder having 11 barrels, 44 L/D, electric heating, and water cooling. The motor is rated at 40 horsepower. The gearbox ratio is 1:89, and the maximum screw speed is 1,200 RPM. Maximum torque for this line is 106 Nm. Barrel length is 1125 mm per with 11 barrels comprising the entire process section. Screw diameter is 25.5 mm. Extruder barrel I.D. is 25 mm. Nitrogen padding (9.5 SCFH) is maintained at the feed throat during the entire compounding process. The screw design is the ZSK-25 mild screw. The screw RPM is 300.

Polymers are fed to the extruder using a single auger screw K-tron T-20 polymer feeder. The feed rate is 30 lbs./hr.

The compounded materials are extruded through a 3 mm, 2 hole die into a 6 foot long chilled water bath. The strands are passed thru a Huestis Air Block to remove excess water. The cooled and dried strands are pelletized with the Conair strand pelletizer.

The properties of each HDPE blend are measured. In addition, the properties of each virgin polymer are measured.

The measured properties are listed in Table 3. Examples listed as “IE” are inventive examples, and examples listed as “CE” are comparative examples. The inventive HDPE blends have higher ESCR and NCLS performance as compared with comparative HDPE blends that contain the same level of virgin polymer.

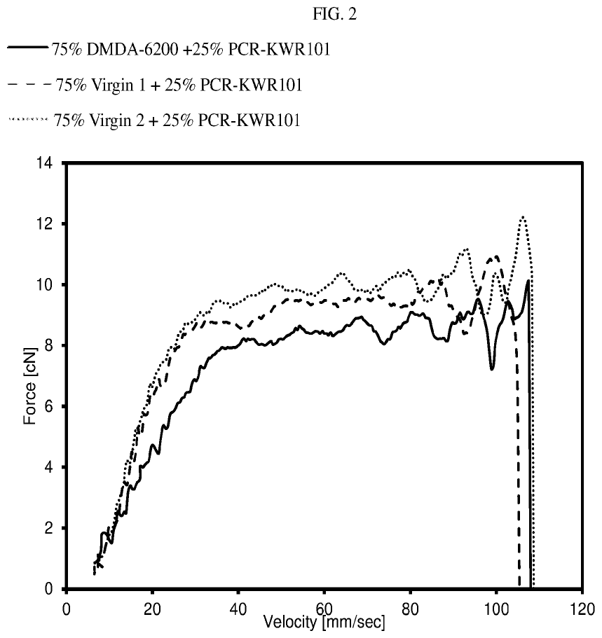

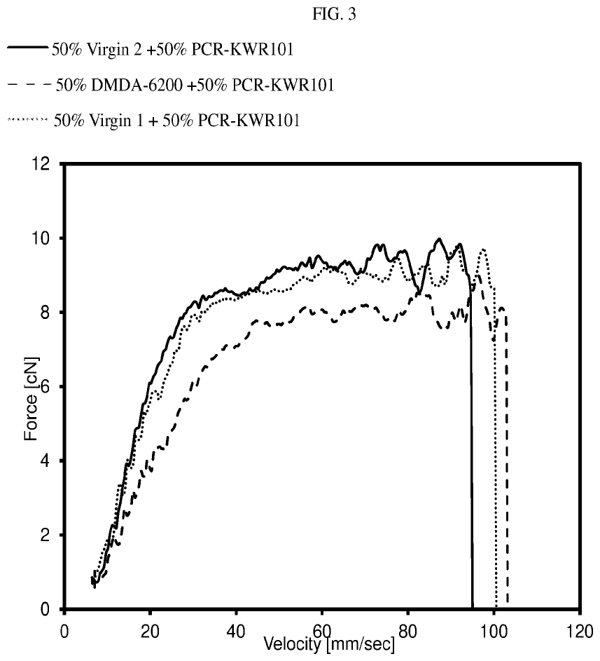

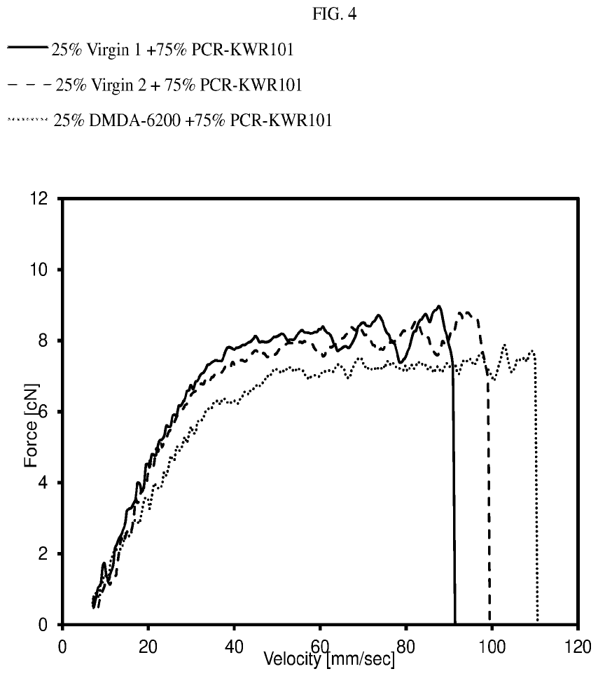

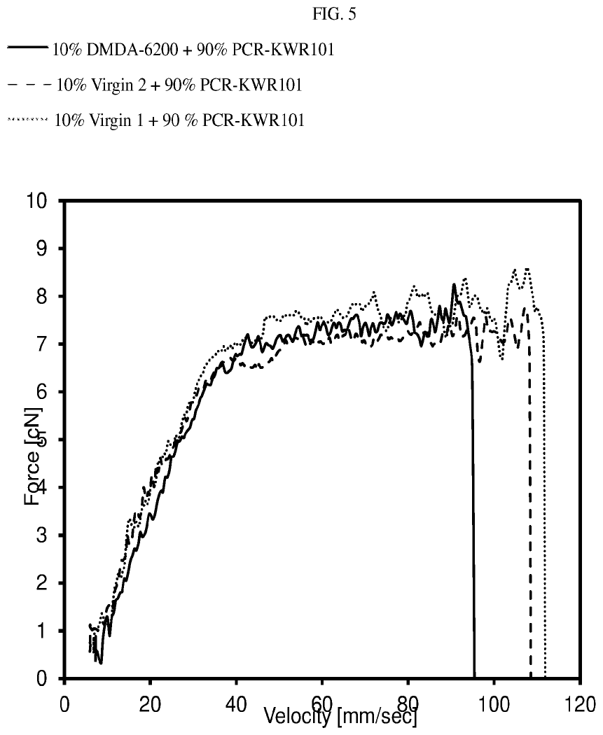

The melt strengths at 190 °C for the samples are shown in FIGS. 1 through 5. In Table 3, the reported melt strength for each sample is the average melt strength observed in the range of velocities for which the sample shows a rough melt strength plateau. It can be observed that for the virgin polymers and the HDPE blends that contain only 10 percent virgin polymer, the melt strength between in inventive and comparative examples are roughly similar. On the other hand, for HDPE blends that contain 25, 50 and 75 weight percent virgin polymer, the inventive HDPE blends have higher melt strength than comparative HDPE blends that contain the same level of virgin polymer.

In Table 3 cN is centinewtons, ksi is kilopounds per square inch, psi is pounds per square inch, kJ/m² is kilojoules per square meter, MPa is megapascals, and hr is hours.

TABLE 3
Properties of Polymers and HDPE/PCR blends.

| | | | Melt | Melt | | | |
|---|---|---|---|---|---|---|---|
| | | | Index | Index | | Flex. | Stress |
| | | | (I₂) | (I₂₁) | | Mod. | at |
| Ex | | Density | (g/10 | (g/10 | | 2% | Yield |
| No | Sample | (g/cc) | min) | min) | I₂₁/I₅ | (ksi) | (psi) |
| IE1 | 75% Virgin Bimodal | 0.957 | 0.178 | 33.9 | 29 | 155 | 3910 |
| | HDPE 1 + 25% PCR | | | | | | |
| IE2 | 50% Virgin Bimodal | 0.958 | 0.231 | 39.6 | 27 | 160 | 3928 |
| | HDPE 1 + 50% PCR | | | | | | |
| IE3 | 25% Virgin Bimodal | 0.959 | 0.382 | 47.0 | 23 | 169 | 4094 |
| | HDPE 1 + 75% PCR | | | | | | |
| IE4 | 10% Virgin Bimodal | 0.960 | 0.515 | 55.5 | 21 | 164 | 4030 |
| | HDPE 1 + 90% PCR | | | | | | |
| IE5 | 75% Virgin Bimodal | 0.957 | 0.149 | 31.5 | 32 | 153 | 3852 |
| | HDPE 2 + 25% PCR | | | | | | |
| IE6 | 50% Virgin Bimodal | 0.958 | 0.198 | 37.4 | 30 | 155 | 4032 |
| | HDPE 2 + 50% PCR | | | | | | |
| IE7 | 25% Virgin Bimodal | 0.960 | 0.377 | 47.2 | 23 | 164 | 4102 |
| | HDPE 2 + 75% PCR | | | | | | |
| IE8 | 10% Virgin Bimodal | 0.960 | 0.517 | 56.0 | 21 | 164 | 4070 |
| | HDPE 2 + 90% PCR | | | | | | |
| CE1 | 100% DMDA-6200 | 0.953 | 0.331 | 31.3 | 20 | 151 | 3878 |
| CE2 | 75% DMDA-6200 + | 0.955 | 0.439 | 41.4 | 20 | 147 | 3870 |
| | 25% PCR | | | | | | |
| CE3 | 50% DMDA-6200 + | 0.957 | 0.492 | 47.9 | 20 | 156 | 3816 |
| | 50% PCR | | | | | | |
| CE4 | 25% DMDA-6200 + | 0.959 | 0.591 | 52.2 | 19 | 157 | 4044 |
| | 75% PCR | | | | | | |
| CE5 | 10% DMDA-6200 + | 0.960 | 0.618 | 57.9 | 20 | 163 | 4202 |
| | 90% PCR | | | | | | |
| CE6 | 100% Virgin | 0.953 | 0.171 | 32.5 | 28 | 158 | 3698 |
| | Bimodal HDPE 1 | | | | | | |
| CE6 | 100% Virgin | 0.953 | 0.132 | 30.0 | 33 | 154 | 3802 |
| | Bimodal HDPE 2 | | | | | | |
| CE7 | 100% PCR | 0.961 | 0.63 | 56.7 | 19 | 171 | N/k |
| | KWR-101 | | | | | | |

N/k means not known.

TABLE 3
Continued
Properties of Polymers and HDPE/PCR blends.

| | | Strain | | | 10% | | |
|---|---|---|---|---|---|---|---|
| | | at | −40 °C | | ESCR | | Melt |
| Ex | | break | Charpy | SHM | F50 | NCLS | Strength |
| No | Sample | (%) | (KJ/m²) | (MPa) | (hr) | (hr) | (cN) |
| IE1 | 75% Virgin Bimodal | 744 | 5.8 | 17.9 | 52 | 136 | 9.5 |
| | HDPE 1 + 25% PCR | | | | | | |
| IE2 | 50% Virgin Bimodal | 777 | 5.1 | 14.2 | 52 | 50 | 9.2 |
| | HDPE 1 + 50% PCR | | | | | | |
| IE3 | 25% Virgin Bimodal | 828 | 5.3 | 9.1 | 21 | 29 | 8.2 |
| | HDPE 1 + 75% PCR | | | | | | |
| IE4 | 10% Virgin Bimodal | 744 | 4.8 | 10.9 | 21 | 20 | 7.2 |
| | HDPE 1 + 90% PCR | | | | | | |
| IE5 | 75% Virgin Bimodal | 738 | 6.7 | 18.7 | 131 | 158 | 10.1 |
| | HDPE 2 + 25% PCR | | | | | | |
| IE6 | 50% Virgin Bimodal | 776 | 5.9 | 15.8 | 47 | 80 | 9.4 |
| | HDPE 2 + 50% PCR | | | | | | |
| IE7 | 25% Virgin Bimodal | 738 | 5.4 | 11.9 | 25 | 27 | 8.1 |
| | HDPE 2 + 75% PCR | | | | | | |
| IE8 | 10% Virgin Bimodal | 758 | 5.0 | 9.6 | 20 | 20 | 7.7 |
| | HDPE 2 + 90% PCR | | | | | | |
| CE1 | 100% DMDA-6200 | 831 | 6.0 | 12.7 | 22 | 18 | 10.8 |
| CE2 | 75% DMDA-6200 + | 610 | 5.4 | 12.1 | 20 | 27 | 8.5 |
| | 25% PCR | | | | | | |
| CE3 | 50% DMDA-6200 + | 893 | 5.0 | 11.2 | 20 | 20 | 8.1 |
| | 50% PCR | | | | | | |
| CE4 | 25% DMDA-6200 + | 705 | 5.6 | 9.4 | 20 | 17 | 7.3 |
| | 75% PCR | | | | | | |
| CE5 | 10% DMDA-6200 + | 828 | 5.7 | 8.1 | 20 | 16 | 7.3 |
| | 90% PCR | | | | | | |
| CE6 | 100% Virgin | 823 | 8.0 | 18.7 | 339 | 366 | 10.5 |
| | Bimodal HDPE 1 | | | | | | |
| CE6 | 100% Virgin | 752 | 9.0 | 23.0 | 762 | 778 | 10.7 |
| | Bimodal HDPE 2 | | | | | | |
| CE7 | 100% PCR | N/k | 5.2 | N/k | 20 | N/k | N/k |
| | KWR-101 | | | | | | |

N/k means not known.

1. A high-density polyethylene blend comprising: (a) from 25 to 90 weight percent of a recycled high-density polyethylene; and (b) from 10 to 75 weight percent of a virgin bimodal high-density polyethylene having a density from 0.940 gram per cubic centimeter (g/cc) to 0.956 g/cc and a flow index (I₂₁) from 25 grams per 10 minutes (g/10 min.) to 40 g/10 min.

2. The high-density polyethylene blend of claim 1 wherein the recycled high-density polyethylene is a post-consumer recycled polymer.

3. The high-density polyethylene blend of claim 1 wherein the virgin bimodal high-density polyethylene has a density from 0.945 g/cc to 0.955 g/cc.

4. The high-density polyethylene blend of any one of claim 1 wherein the virgin bimodal high-density polyethylene has a flow index (I₂₁) from 28 g/10 min to 35 g/10 min.

5. The high-density polyethylene blend of claim 1 wherein the virgin bimodal high-density polyethylene has a timed die swell (time to reach 25.4 cm diameter) at a shear rate of 300 per second (s⁻¹) from 23 seconds to 30 seconds.

6. The high-density polyethylene blend of claim 1 which has a density from 0.950 g/cc to 0.965 g/cc, or a flow index (I₂₁) from 28 g/10 min. to 60 g/10 min., or both properties.

7. The high-density polyethylene blend of any one of claim 1 which contains at least 45 weight percent of the recycled high-density polyethylene.

8. The high-density polyethylene blend of claim 7 which has an ESCR of at least 30 hours as measured according to ASTM D 1693-13, Condition B, with at 10% surfactant in water; or which has a melt strength of at least 8.5 cN; or which has the ESCR of at least 30 hours and the melt strength of at least 8.5 cN.

9. The high-density polyethylene blend of claim 1 which contains at least 70 weight percent recycled high-density polyethylene.

10. The high-density polyethylene blend of claim 9 which has an NCLS of at least 21 hours as measured according to ASTM F2136; or which has a melt strength of at least 7.5 cN;
or which has the NCLS of at least 21 hours and the melt strength of at least 7.5 cN.

11. The high-density polyethylene blend of claim 1 wherein the virgin bimodal high-density polyethylene (HDPE) copolymer comprises from 22.5 weight percent (wt %) to 29.4 wt % of a higher molecular weight HDPE copolymer component (HMW copolymer component) and from 77.5 wt % to 70.6 wt %, respectively, of a lower molecular weight HDPE copolymer component (LMW copolymer component), wherein the copolymer has each of properties (a) to (g):
(a) a density from 0.940 g/cc to 0.956 g/cc;
(b) a flow index (I₂₁) from 25.0 g/10 min. to 40.0 g/10 min.;
(c) a ratio of Mw/Mn from 12 to 18 or a ratio of Mz/Mw of 15.0 to 17.0 or both ratios, wherein Mw is weight-average molecular weight and Mn is number-average molecular weight and Mz is z-average molecular weight, all measured by Conventional Gel Permeation Chromatography (GPC);
(d) a melt strength of at least 9 centinewtons (cN), measured at 190 °C by Melt Strength Test Method;
(e) the ratio of low shear viscosity to high shear viscosity (η_{0.1}/η₁₀₀) from 40 to 100, measured according to Shear Viscosity Determination Method;
(f) an environmental stress cracking resistance (ESCR) greater than 300 hours, measured according to ASTM D1693-15, Method B (10% Igepal, F50); and
(g) a timed die swell (time to reach 25.4 cm diameter) at a shear rate of 300 per second (s⁻¹) from 23 seconds to 27 seconds or a timed die swell (time to reach 25.4 cm diameter) at a shear rate of 1000 s⁻¹ of 8.3 to 8.8 seconds or both; and
wherein the wt % of the HMW copolymer component and the wt % of the LMW copolymer component are based on the total weight thereof.

12. A shaped article comprising the high-density polyethylene blend of claim 1.

13. A blow molding process comprising the steps of: (1) placing a quantity of molten high-density polyethylene (HDPE) blend in a mold cavity, (2) blowing a gas into the molten HDPE blend, causing it to expand and assume the approximate shape of the mold cavity, and (3) cooling the HDPE blend, wherein the HDPE blend is the high-density polyethylene blend of claim 1.

14. A blow molded article prepared by the process of claim 13.
